(19) United States
(12) Patent Application Publication
(10) Pub. No.: US 2021/0390053 A1
(43) Pub. Date: Dec. 16, 2021

(54) Host-Assisted Memory-Side Prefetcher

(71) Applicant: Micron Technology, Inc., Boise, ID (US)

(72) Inventor: David Andrew Roberts, Wellesley, MA (US)

(73) Assignee: Micron Technology, Inc., Boise, ID (US)

(21) Appl. No.: 16/901,890

(22) Filed: Jun. 15, 2020

(51) Int. Cl. G06F 12/0862; G06F 12/0873; G06F 12/06; G06F 9/30; G06F 9/50; G06F 9/54; G06N 3/04

(52) U.S. Cl. CPC G06F 12/0862; G06F 12/0873; G06F 12/0646; G06F 9/30138; G06F 2209/508; G06F 9/5016; G06F 9/544; G06N 3/0454; G06F 9/30047

(57) ABSTRACT

Methods, apparatuses, and techniques related to a host-assisted memory-side prefetcher are described herein. In general, prefetchers monitor the pattern of memory-address requests by a host device and use the pattern information to determine or predict future memory-address requests and fetch data associated with those predicted requests into a faster memory. In many cases, prefetchers that can make predictions with high performance use appreciable processing and computing resources, power, and cooling. Generally, however, producing a prefetching configuration that the prefetcher uses involves more resources than making predictions. The described host-assisted memory-side prefetcher uses the greater computing resources of the host device to produce at least an updated prefetching configuration. The memory-side prefetcher uses the prefetching configuration to predict the data to prefetch into the faster memory, which allows a higher-performance prefetcher to be implemented in the memory device with a reduced resource burden on the memory device.

### BACKGROUND

Prefetchers are circuits that attempt to predict data that will be requested by a processor of a host device and write the data into a faster intermediate memory, such as a cache memory or a buffer, before the processor requests the data. When the prefetcher is configured properly, this can reduce memory latency, which can be useful because lower latency allows programs and applications that are running on the host device to access data faster. There are many types of prefetchers, with different configurations and algorithms, including prefetchers that use cache-miss history tables, stride tables, or artificial neural networks, such as deep neural network (DNN)-based systems.

### BRIEF DESCRIPTION OF THE DRAWINGS

Apparatuses of and techniques for a host-assisted memory-side prefetcher are described with reference to the following drawings. The same numbers are used throughout the drawings to reference like features and components:

FIG. 1 illustrates an example apparatus in which various techniques and devices related to the host-assisted memory-side prefetcher can be implemented.

FIG. 2 illustrates an example apparatus, including an interconnect, coupled between a host device and a memory device, that can implement aspects of a host-assisted memory-side prefetcher.

FIG. 3 illustrates another example apparatus, including a memory device coupled to an interconnect, that can implement aspects of a host-assisted memory-side prefetcher.

FIG. 4 illustrates another example apparatus, including a host device coupled to an interconnect, that can implement aspects of a host-assisted memory-side prefetcher.

FIG. 5 illustrates an example sequence diagram depicting operations performed by a host device and by a memory device that includes a prefetch engine, in accordance with the host-assisted memory-side prefetcher.

FIG. 6 illustrates example methods for an apparatus to implement a host-assisted memory-side prefetcher.

### DETAILED DESCRIPTION

### Overview

This document describes a host-assisted memory-side prefetcher. Computers and other electronic devices provide services and features using a processor that is communicatively coupled to a memory. Because processors can often request and use data faster than some memories can accommodate, an intermediate memory, such as a cache memory or a buffer, may be logically inserted between the processor and the memory. This transforms the memory into a slower backing memory for a faster intermediate memory, which can be combined into a single memory device. To request data from this memory device, the processor provides to the memory device a memory request including a memory address of the data. To respond to the memory request, a controller of the intermediate memory can determine whether the requested data is currently present in an array of memory cells of the intermediate memory. If the requested data is in the intermediate memory (e.g., an intermediate or cache memory “hit”), the controller provides the data to the processor from the intermediate memory. If the requested data is not in the intermediate memory (e.g., an intermediate or cache memory “miss”), the controller provides the data to the processor from the backing memory. Because some of the memory requests are serviced using the intermediate memory, this process can reduce memory latency, which allows the processor to receive requested data sooner and therefore operate faster.

A prefetcher can be realized as a circuit or other hardware that can determine (e.g., predict or statistically anticipate) data that may be requested from the backing memory by the processor and write or load the predicted data into the faster intermediate memory before the processor requests the data. Prefetchers may be integrated with, or coupled to, either the memory device (a memory-side prefetcher) or the host device (a host-side prefetcher). In general, prefetchers monitor the pattern of memory-address requests by the processor (e.g., monitor what addresses are requested or what addresses are repeatedly requested, and how often). Prefetchers use the pattern information to predict future memory-address requests and, before a given request, prefetch the data associated with that predicted request. Prefetchers can use a prefetching configuration to monitor and analyze the pattern of memory-address requests to predict what data should be prefetched into the intermediate memory. Many different prefetching configurations can be used, including memory-access-history tables (e.g., a stride table), a Markov model, or a trained artificial neural network (also referred to as a neural network or a NN). When a prefetcher is configured properly, this can further reduce memory latency.

In most cases, prefetchers that can make these predictions with high performance (e.g., with high bandwidth and low latency) require significant processing and computing resources, power, and cooling. Generally, prefetching involves producing a prefetching configuration and using the prefetching configuration to make predictions. The producing of the prefetching configuration includes, for example, creating and training a neural network or determining, storing, and maintaining memory-access-history tables or other data for stride- or Markov-model-based prefetchers. This producing can demand appreciably more processing and computing resources than using the prefetching configuration to make the predictions. Although these two aspects of prefetching have different processing demands, existing approaches perform both aspects in a single location—e.g., the host side or the memory side of an electronic device.

In contrast, in the described host-assisted memory-side prefetcher, the greater computing and processing resources of a host device are used to produce the prefetching configuration and provide it to a memory-side prefetcher, which can be part of a memory device. The memory-side prefetcher can then use the prefetching configuration to predict data and prefetch the data into the intermediate memory. In this way, the disclosed host-assisted memory-side prefetcher can allow a high-performance prefetcher to be implemented in the memory device while allowing for a reduced resource burden on the memory device.

Consider an example implementation of the described host-assisted memory-side prefetcher in which the host device includes a graphics processing unit (GPU), and the memory-side prefetcher is realized as a neural network-based prefetcher. The neural network-based prefetcher can be implemented in a neural-network accelerator with an inference engine (or prefetch engine) that uses a trained artificial neural network to predict the data to fetch to the intermediate memory. For example, the artificial neural network can be a recurrent neural network with long short-term memory (LSTM) architecture. In this example implementation, the GPU also includes prefetch logic (e.g., a prefetch logic module or a neural network module) that can produce the neural network and provide parameters specifying the neural network to the neural network-based prefetcher. The prefetch logic can also train (and retrain) the neural network based on information provided by the memory-side prefetcher, which can track prefetching success.

In the ordinary course of operation in a prefetching environment, the memory-side prefetcher provides data to the intermediate memory based on various criteria, including the prefetching configuration (e.g., the neural network). As the host device operates, it sends memory requests to the memory device (e.g., a data address of the backing memory). If the requested data is in the intermediate memory (which is a “hit”), the data is provided to the processor from the intermediate memory. If the requested data is not in the intermediate memory (which is a “miss”), the data is provided to the processor from the backing memory.

The memory device then returns to the host device a prefetch-success indicator (e.g., a hit/miss indication for each requested data address). For example, for every requested data address, the memory device can tell the host device whether a prediction was successful. The memory device can tell the host device that the requested data address was read from the intermediate memory before it was evicted. The prefetch logic of the host device can then use the prefetch-success indicator to train or retrain the neural network by, for example, updating the network structure (e.g., the types and number of layers or nodes, or the number of interconnections between nodes), the weights of nodal connections, or the biases of the neural network. In this way, the host-assisted memory-side prefetcher can take advantage of the greater computing resources of the host device (e.g., the GPU, CPU, or tensor core) to improve memory system performance because it enables more-complex and more-accurate prefetching configurations than may otherwise be accommodated efficiently, if at all, in memory-side logic.

The prefetch logic may perform the training or retraining periodically or in response to a trigger event. Trigger events can include the host device starting new operations, such as a new program, process, workload, or thread, and a change in prefetching effectiveness (e.g., the hit rate decreases by five percent or falls below a threshold level). The prefetch logic may operate in at least three training modes. These training modes can include, for example, a mode in which retraining is only periodic, a mode in which retraining is only event-based, or a combined mode in which the prefetch logic may have a periodic retraining schedule but can vary from the schedule in response to a trigger event. By retraining a prefetcher to update the prefetching configuration, the prefetcher can accommodate changing memory access patterns to maintain a high prefetching performance over time.

For some host devices, the prefetch logic can also provide multiple prefetching configurations that are customized for particular programs or workloads. Because prefetchers rely on patterns of memory-use to make predictions, the accuracy and usefulness of the prefetcher can degrade when the host-device processor runs different workloads. To mitigate this, the prefetch logic can produce different prefetching configurations that are respectively associated with different programs or workloads. When the host device starts operating the associated program or workload, the prefetch logic provides the appropriate configuration (e.g., neural network or data table) that is trained specifically for the associated operations. The memory-side prefetcher can then use this workload-specific configuration to make predictions, which allows the prefetcher to maintain accuracy and performance across different memory-access patterns of the different workloads.

Consider an example implementation in which a host-assisted memory-side prefetcher is implemented in a distributed manner across a memory device and a host device having a memory controller and a processor. The host device includes prefetch logic, such as a neural network module that can train a neural network using observational data (history data) or other data. The neural network module can also provide the trained neural network to a memory-side prefetcher based on an associated operating state, such as a program, workload, or thread. In this example architecture, the memory device implements a neural network-based prefetcher that can predict data to write or load into an intermediate memory and calculate a prefetch-success indicator based on, for instance, a cache-hit/miss rate. The intermediate memory may include any of a variety of memory devices, such as a host-side cache memory, a host-side buffer memory, a memory-side cache memory, a memory-side buffer memory, or any combination thereof. The prefetch logic of the host device then obtains the prefetch-success indicator from the memory device and uses the prefetch-success indicator to update the neural network configuration (e.g., weights and biases). The updated neural network configuration is then returned to the memory device as an updated prefetching configuration. In some implementations, where the prefetching configuration is a neural network, returning the updated neural network configuration to the prefetcher can be performed gradually, such as by using idle bandwidth between the host device and the memory device.

By implementing the host-assisted memory-side prefetcher, memory-side prefetchers may be able to operate with more-complex and more-accurate prefetching configurations. The greater compute (and other main memory or backing storage) resources of a host-side processor can be used to produce and train a prefetching configuration, including a neural network, which can be customized for use with different programs, processes, and workloads. The host device provides the prefetching configuration to the memory-side prefetcher. The memory-side prefetcher uses the prefetching configuration to efficiently and accurately prefetch data into an intermediate memory, such as a memory-side cache or buffer, or push prefetched data directly into a host-side cache or buffer. In some cases, the memory-side prefetcher can use the prefetching configuration to prefetch data into the memory of a peripheral device, such as a GPU attached to a CPU. This can allow the memory-side prefetcher to provide higher performance without having to add computing resources or cooling capacity to a memory device.

These are but a few examples of how a host-assisted memory-side prefetcher can be implemented. Other examples and implementations are described throughout this document. The document now turns to an example apparatus, after which example devices and methods are described.

### Example Apparatuses

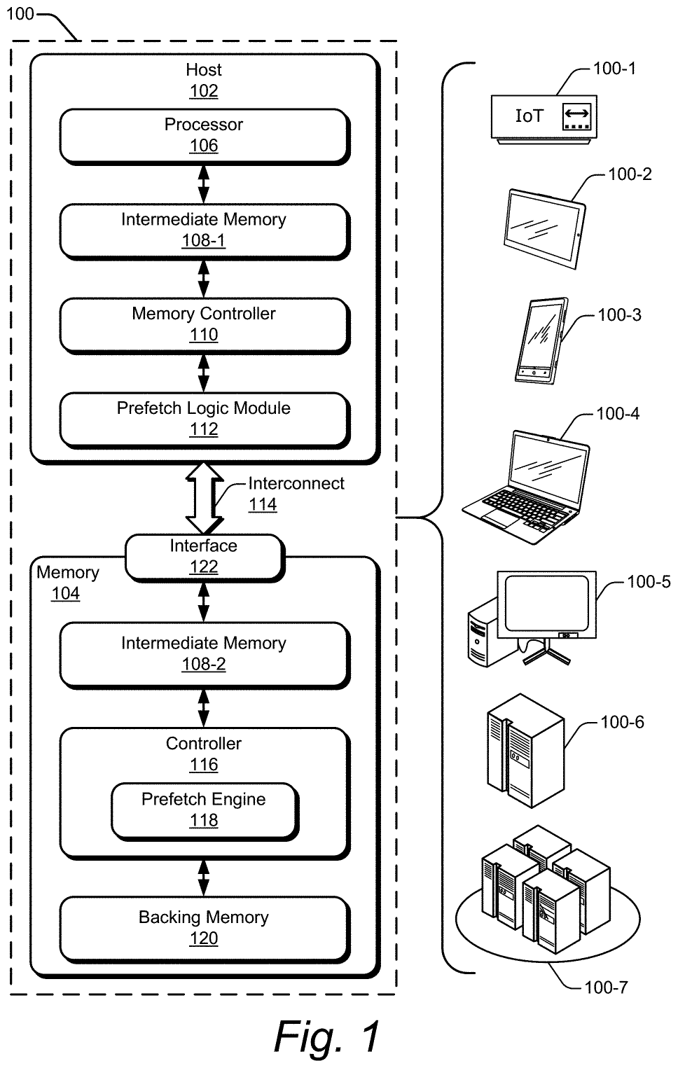

FIG. 1 illustrates an example apparatus 100 that can implement various techniques and devices described in this document. The example apparatus 100 can be realized as various electronic devices. Example electronic-device implementations include an internet-of-things (IoT) device 100-1, a tablet device 100-2, a smartphone 100-3, a notebook computer 100-4, a desktop computer 100-5, a server computer 100-6, and a server cluster 100-7. Other examples include a wearable device, such as a smartwatch or intelligent glasses; an entertainment device, such as a gaming device, a set-top box, or a smart television; a motherboard or server blade; a consumer appliance; vehicles or electronics thereof; industrial equipment; and so forth. Each type of electronic device includes one or more components to provide a computing functionality or feature.

In example implementations, the apparatus 100 includes at least one host 102, at least one memory 104, at least one processor 106, and at least one intermediate memory 108 (e.g., a memory-side cache memory, a host-side cache memory, a memory-side buffer memory, or a host-side buffer memory). The apparatus 100 can also include at least one memory controller 110, at least one prefetch logic module 112, and at least one interconnect 114. The apparatus 100 can also include at least one controller 116, which may include at least one prefetch engine 118, and at least one backing memory 120. The controller 116 may be implemented in any of a variety of manners. For example, the controller 116 can include or be an artificial intelligence accelerator (e.g., a Micron Deep Learning Accelerator™ (DLA) or another accelerator) or a prefetcher controller. The prefetch engine 118 can be implemented in various manners, including as an inference engine (e.g., a Micron/FWDNXT™ inference engine) or other prediction logic. The backing memory 120 may be realized with a dynamic random-access memory (DRAM) device or module or a three-dimensional (3D) stacked DRAM device, such as a high bandwidth memory (HBM) device or a hybrid memory cube (HMC) device. Additionally or alternatively, the backing memory 120 may be realized with a storage-class memory device, such as one employing 3D XPoint™ or phase-change memory (PCM). The backing memory 120 can also be formed from nonvolatile memory (NVM) (e.g., flash memory). Other examples of the backing memory 120 are described herein.

As shown, the host 102, or host device 102, includes the processor 106, at least one intermediate memory 108-1, the memory controller 110, and the prefetch logic module 112. The processor 106 is coupled to the intermediate memory 108-1, the intermediate memory 108-1 is coupled to the memory controller 110, and the memory controller 110 is coupled to the prefetch logic module 112. The processor 106 is also coupled, directly or indirectly, to the memory controller 110 and the prefetch logic module 112. The host device 102 is coupled to the memory 104 through the interconnect 114.

The memory 104, or memory device 104, includes at least one intermediate memory 108-2, the controller 116, the prefetch engine 118, and the backing memory 120. The intermediate memory 108-2 is coupled to the controller 116 and the prefetch engine 118. The controller 116 and the prefetch engine 118 are coupled to the backing memory 120. The intermediate memory 108-2 is also coupled, directly or indirectly, to the backing memory 120. The memory device 104 is coupled to the host device 102 through one or more interconnects. As shown, the memory device 104 is coupled to the host device 102 through the interconnect 114, using an interface 122. In some implementations, other or additional combinations of interconnects and interfaces may provide the coupling between the memory device 104 and the host device 102.

The interface 122 can be implemented as any of a variety of circuitries, devices, or systems capable of enabling data or other signals to be communicated between the host device 102 and the memory device 104, including buffers, latches, drivers, receivers, or a protocol to operate them. For example, the interface 122 can be realized as a programmable interface, such as one or more memory-mapped registers on the memory device 104 that are part of or coupled to the controller 116 (e.g., via the interconnect 114). As another example, the interface 122 can be realized as a shared-memory-protocol interface in which the memory device 104 (e.g., through the controller 116) can write directly to a memory of the host device 102 (e.g., to a DRAM portion thereof). The interface 122 can also or instead implement a signaling protocol across the interconnect 114. Other examples and details of the interface 122 are described herein.

The depicted components of the apparatus 100 represent an example computing architecture with a hierarchical memory system. For example, the intermediate memory 108-1 is logically coupled between the processor 106 and the intermediate memory 108-2. Further, the intermediate memory 108-2 is logically coupled between the processor 106 and the backing memory 120. Here, the intermediate memory 108-1 is at a higher level of the hierarchical memory system than is the intermediate memory 108-2. Similarly, the intermediate memory 108-2 is at a higher level of the hierarchical memory system than is the backing memory 120. The indicated interconnect 114, as well as the other interconnects that communicatively couple together various components, enable data to be transferred between or among the various components. Interconnect examples include a bus, a switching fabric, one or more wires that carry voltage or current signals, and so forth.

Although particular implementations of the example apparatus 100 are depicted in FIG. 1 and described herein, the apparatus 100 can be implemented in alternative manners. For example, the host device 102 may include multiple intermediate memories, including multiple levels of intermediate memory. Further, at least one other intermediate memory and backing memory pair may be coupled “below” the illustrated intermediate memory 108-2 and backing memory 120. The intermediate memory 108-2 and the backing memory 120 may be realized in various manners. In some cases, the intermediate memory 108-2 and the backing memory 120 are both disposed on, or physically supported by, a motherboard with the backing memory 120 comprising “main memory.” In other cases, the intermediate memory 108-2 comprises DRAM, and the backing memory 120 comprises flash memory or a magnetic hard drive. Nonetheless, the components may be implemented in alternative ways, including in distributed or shared memory systems. Further, a given apparatus 100 may include more, fewer, or different components.

### Example Schemes, Techniques, and Hardware

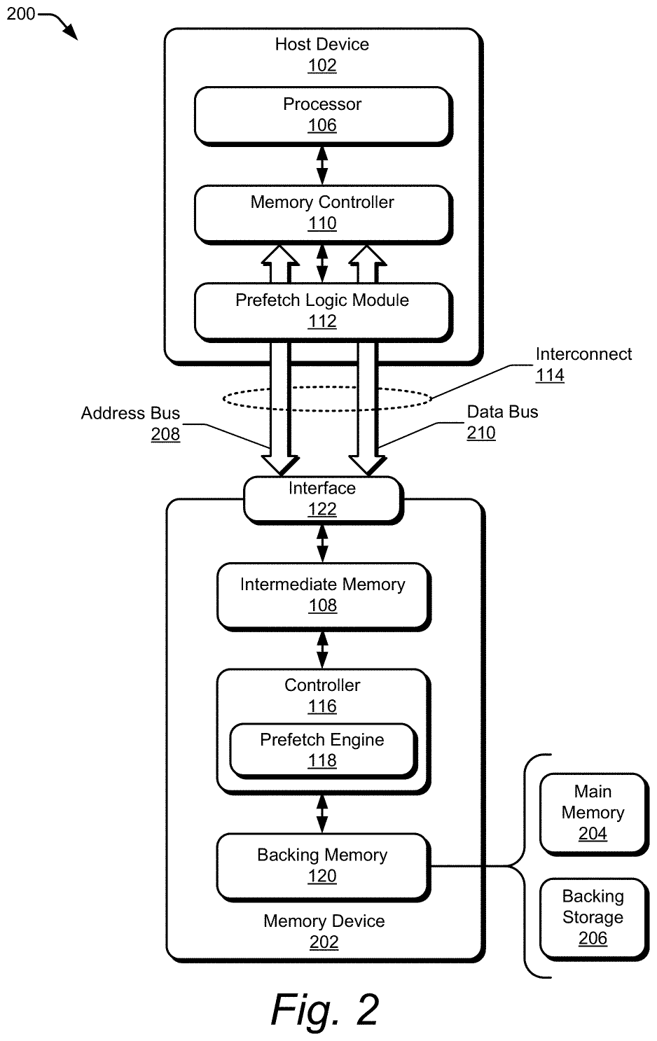

FIG. 2 illustrates, generally at 200, an example apparatus, including an interconnect 114 coupled between the host device 102 and the memory device 104, which is illustrated as an example memory device 202 of an apparatus (e.g., at least one example electronic device as described with reference to the example apparatus 100 of FIG. 1). For clarity, the host device 102 is depicted to include the processor 106, the memory controller 110, and the prefetch logic module 112, but the host device 102 may include more, fewer, or different components.

In example implementations, the memory device 202 can include at least one intermediate memory 108, the controller 116, the prefetch engine 118, and at least one backing memory 120. The intermediate memory 108 can include a cache memory or another memory. The backing memory 120 serves as a backstop to handle memory requests that the intermediate memory 108 is unable to satisfy. The backing memory 120 can include a main memory 204, a backing storage 206, another intermediate memory (e.g., a larger intermediate memory at a lower hierarchical level followed by a main memory), a combination thereof, and so forth. For example, the backing memory 120 may include both the main memory 204 and the backing storage 206. Alternatively, the backing memory 120 may include the backing storage 206 that is fronted by the intermediate memory 108 (e.g., a solid-state drive (SSD) or magnetic disk drive (or hard drive) may be mated with a DRAM-based intermediate memory). Further, the backing memory 120 may be implemented using the main memory 204, and the memory device 202 may therefore include the intermediate memory 108 and the main memory 204 that are organized or operated in one or more different configurations, such as storage-class memory. In some cases, the main memory 204 can be formed from volatile memory while the backing storage 206 can be formed from nonvolatile memory. Additionally, the backing memory may be formed from a combination of any of the memory types, devices, or modules described in this document, such as a RAM coupled to an SSD.

The host device 102 is coupled to the memory device 202 via the interconnect 114, using the interface 122. Here, the interconnect 114 is separated into at least an address bus 208 and a data bus 210. In other implementations, the interconnect 114 may include the address bus 208, the data bus 210, a command bus (not shown), or any combination thereof. Further, the electrical paths or couplings realizing the interconnect can be shared between two or more buses. For example, one set of electrical paths can provide a combination address bus and command bus, and another set of electrical paths can provide a data bus. Alternatively, one set of electrical paths can provide a combination data bus and command bus, and another set of electrical paths can provide an address bus. Accordingly, memory addresses are communicated via the address bus 208, and data is communicated via the data bus 210. Prefetching configurations, prefetch-success indicators, or other communications—such as memory requests, commands, messages, or instructions—can be communicated on the address bus 208, the data bus 210, a command bus (not shown), or a combination thereof.

In some cases, the host device 102 and the memory device 202 are implemented as separate integrated circuit (IC) chips. In other words, the host device 102 may include at least one IC chip, and the memory device 202 may include at least one other IC chip. These chips may be in separate packages or modules, may be mounted on a same printed circuit board (PCB), may be disposed on separate PCBs, and so forth. In each of these environments, the interconnect 114 can provide an inter-chip coupling between the host device 102 and the memory device 202. An interconnect 114 can operate in accordance with one or more standards. Example standards include DRAM standards published by JEDEC (e.g., DDR, DDR2, DDR3, DDR4, DDR5, etc.); stacked memory standards, such as those for High Bandwidth Memory (HBM) or Hybrid Memory Cube (HMC); a peripheral component interconnect (PCI) standard, such as the Peripheral Component Interconnect Express (PCIe) standard; the Compute Express Link (CXL) standard; the HyperTransport™ standard; the InfiniBand standard; the Gen-Z Consortium standard; the External Serial AT Attachment (eSATA) standard; and an accelerator interconnect standard, such as the Coherent Accelerator Processor Interface (CAPI or openCAPI) standard or the Cache Coherent Interconnect for Accelerators (CCIX) protocol. In addition or in alternative to a wired connection, the interconnect 114 may be or may include a wireless connection, such as a connection that employs cellular, wireless local area network (WLAN), wireless personal area network (WPAN), or passive network standard protocols. The memory device 202 can be realized, for instance, as a memory card that supports the host device 102. Although only one memory device 202 is shown, the host device 102 may be coupled to multiple memory devices 202 using one or multiple interconnects 114.

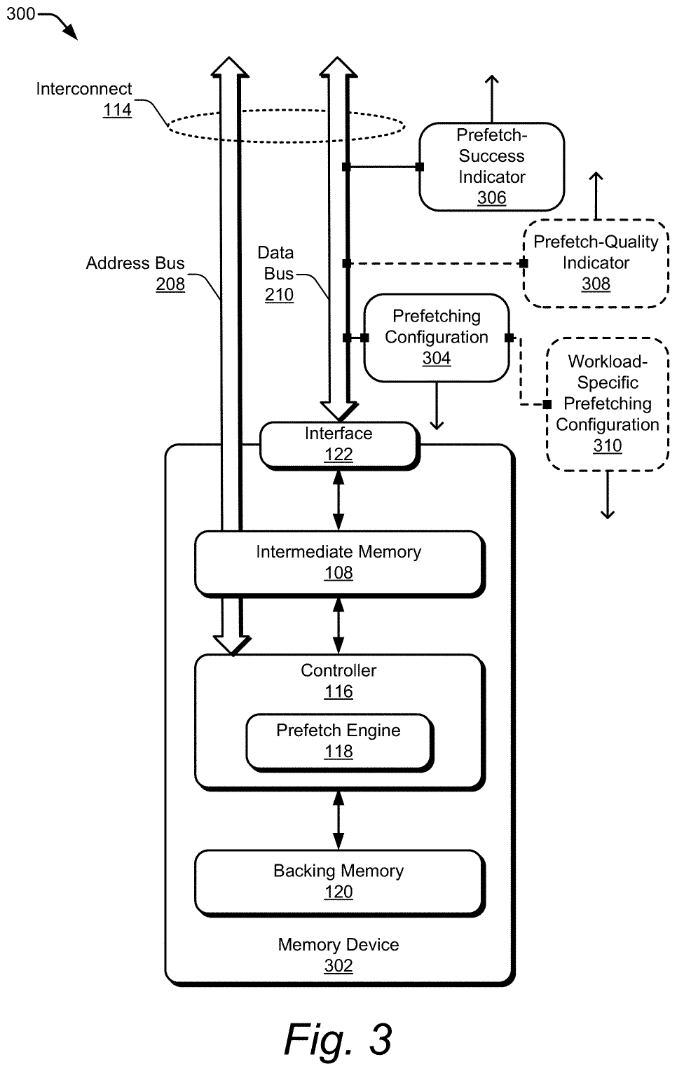

FIG. 3 illustrates another example apparatus 300 that can implement aspects of a host-assisted memory-side prefetcher. The example apparatus 300 comprises the memory device 104, which is illustrated as an example memory device 302, and an interface configured to couple to an interconnect for a host device. The memory device 302 can include the intermediate memory 108, the controller 116, the prefetch engine 118, and the backing memory 120. The interface can be any of a variety of interfaces, such as the interface 122, that can couple the memory device 302 to the interconnect 114. As shown in the example apparatus 300, the interface 122 is coupled to the interconnect 114, which can include at least an address bus 208, a data bus 210, and a command bus (not shown). The intermediate memory 108 is a memory that can store prefetched data (e.g., a cache memory or buffer). For example, the intermediate memory 108 can store data that is prefetched from the backing memory 120. As shown in FIG. 3, the intermediate memory 108 is integrated with the memory device 302 as, for example, a memory-side cache. In other implementations, the intermediate memory 108 may be a separate memory device or a memory device integrated with another device, such as the host device 102 (e.g., as a host-side cache or buffer).

The backing memory 120 is coupled, directly or indirectly, to the intermediate memory 108. The controller 116 is coupled, directly or indirectly, to the intermediate memory 108, the backing memory 120, and the interface 122. As shown, the prefetch engine 118 is included in the controller 116. In other implementations, however, the prefetch engine 118 may be a separate entity, coupled to the controller 116 and included in, or coupled to, the memory device 302. The controller 116 can be implemented as any of a variety of logic controllers, such as a memory controller, and may include functions such as a memory request queue and management logic (not shown).

In example operations, the prefetch engine 118 can receive a prefetching configuration 304, or a command for the prefetching configuration 304, from another device or location, such as from a network-based or cloud-based service (either directly from the service or through the host device 102) or directly from the host device 102. The command may include a signal or another mechanism that indicates that the prefetch engine 118 is to use a particular prefetching configuration, such as the prefetching configuration 304. For example, the prefetch engine 118 can receive the prefetching configuration 304 (or the command for the prefetching configuration 304) from the host device 102, via the interconnect 114, using the interface 122. Accordingly, the prefetch engine 118 can receive the prefetching configuration 304 via the data bus 210, as shown in FIG. 3. In other implementations, the command or the prefetching configuration 304 may be received over the address bus 208, a command bus (not shown), or a combination of the address bus 208, the data bus 210, or the command bus. In some cases, receiving the prefetching configuration 304 may be optional (e.g., if the prefetch engine 118 includes a pre-installed or default prefetching configuration).

The prefetching configuration 304 can be any of a variety of configurations for specifying a prefetching algorithm, paradigm, model, or technique. For example, when the prefetch engine 118 includes a neural-network-based prefetcher or inference engine, the prefetching configuration 304 can include any of a variety of neural networks, such as a feed-forward neural network, a convolutional neural network, a modular neural network, or a recurrent neural network (RNN) (with or without long short-term memory (LSTM) architecture). In other cases, when the prefetch engine 118 includes another type of prefetcher (e.g., a table-based prefetcher, such as a stride prefetcher or a Markov prefetcher), the prefetching configuration 304 can include any of a variety of different prefetching configurations, such as a memory-access-history table (e.g., with cache-miss data, including cache-miss strides and/or depths) or a Markov model.

Continuing the example operations, the prefetch engine 118 can determine (e.g., predict), based at least in part on the prefetching configuration 304, one or more memory addresses of the backing memory 120 that may be requested by the host device. For example, the prefetch engine 118 can use a trained neural network, such as the RNN described herein, to predict memory addresses that are likely to be requested before the memory addresses actually are requested. This determination (e.g., prediction) uses as inputs, the ongoing series of memory address requests from the host device. In other words, the memory addresses of the backing memory 120 that may be requested by the host device 102 are memory addresses that, from a probabilistic perspective based on the prefetching configuration, will be (or are likely to be) requested by the host device within some future timeframe—e.g., in accordance with operational patterns of code being executed. The future timeframe can include or pertain to a period during which the predicted access occurs and before the prefetched data is replaced in the intermediate memory. The prefetch engine 118 can then write or load data associated with the one or more predicted memory addresses of the backing memory 120 into the intermediate memory based on the prediction.

The prefetch engine 118 can also determine a prefetch-success indicator 306 for the one or more predicted memory addresses and transmit the prefetch-success indicator 306 to the device or other location that provides the prefetching configuration 304 (e.g., the host device 102). The prefetch-success indicator 306 can be an indication that the one or more predicted addresses are accessed at (e.g., read from or written to) the intermediate memory 108 (e.g., by the host device) before the one or more predicted addresses are evicted from the intermediate memory 108.

Optionally, the prefetch engine 118 can also determine a prefetch-quality indicator 308 for the one or more predicted memory addresses and transmit the prefetch-quality indicator 308 to the device or other location that provides the prefetching configuration 304 (e.g., the host device 102). The prefetch-quality indicator 308 can be, for example, an indication of a number of times the one or more predicted memory addresses are accessed using (e.g., read from or written to) the intermediate memory 108 during operation of a program or a workload, or during operation of a portion or subpart of the program or workload. The prefetch engine 118 can determine either or both of the prefetch-success indicator 306 or the prefetch-quality indicator 308 by, for example, monitoring the memory-address requests for the intermediate memory 108, along with the resulting hits and misses. The hits and misses can include, for example, cache misses or cache hits, including the number of each for the memory-address requests.

Either or both of the prefetch-success indicator 306 or the prefetch-quality indicator 308 can be communicated over the interconnect 114, using the interface 122. For example, the memory device 302 may have permissions to directly access or write to a memory of the source of the prefetching configuration 304, such as a host-side DRAM. Accordingly, the memory device 302 can load or drive the prefetch-success indicator 306 over the data bus 210, as shown in FIG. 3. In other implementations, either or both of the prefetch-success indicator 306 or the prefetch-quality indicator 308 may be sent over the address bus 208, a command bus (not shown), or a combination of the address bus 208, the data bus 210, or the command bus.

In still other implementations, the memory device 302, using for example the prefetch engine 118, can set an interrupt flag to notify the host device 102 (or other device or location) that there is data (e.g., the prefetch-success indicator 306, the prefetch-quality indicator 308, or both) available at a particular memory address, memory region, or register. In response to the interrupt, the host device 102 can access the indicator or other data. Similarly, the memory device 302 may periodically set a flag at a memory address or register on the memory device 302, and the host device 102 (or other device or location) can periodically check the flag to determine whether either or both of the prefetch-success indicator 306 or the prefetch-quality indicator 308 is available. In some implementations, one or more of the actions of writing or loading the data associated with the one or more predicted memory addresses into the intermediate memory, determining the prefetch-success indicator 306 (and/or the prefetch-quality indicator 308), or transmitting either or both of the prefetch-success indicator 306 or the prefetch-quality indicator 308 may be managed, directed, or performed by an entity other than the prefetch engine 118, such as the controller 116.

The described apparatuses and techniques for a host-assisted memory-side prefetcher allow complex, sophisticated, and accurate prefetching configurations that may not otherwise be available for a memory-side prefetcher because of the resources involved to produce and maintain these types of configurations. In turn, memory and storage system performance can be improved (e.g., memory latency may be reduced), thereby enabling the host device to operate faster and more efficiently.

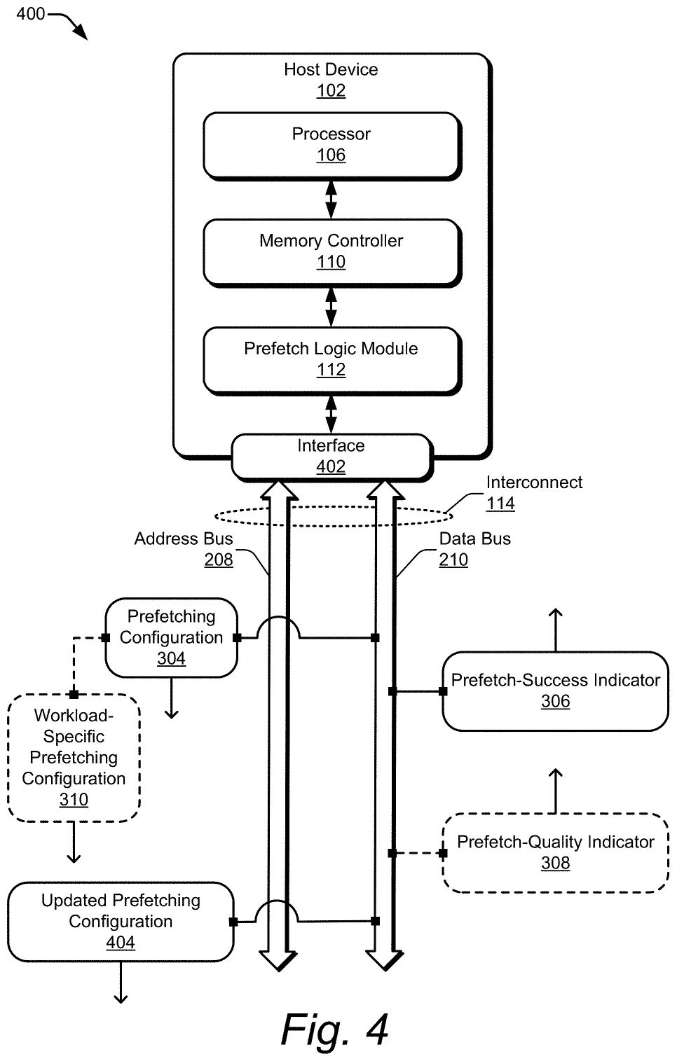

In some implementations (not shown in FIG. 3), the example apparatus 300 can also include a host device (e.g., the host device 102 of FIG. 1, 2, 4, or 5) that includes logic, such as the prefetch logic module 112, that can determine the prefetching configuration 304 and transmit the prefetching configuration 304 over the interconnect 114. The prefetch logic module 112 (e.g., of FIGS. 2 and 4) can transmit the prefetching configuration 304 or the command for the prefetching configuration 304 over the data bus 210, the address bus 208, a command bus, or a combination of the address bus 208, the data bus 210, or the command bus. The prefetch logic module 112 can also receive the prefetch-success indicator 306 from the interconnect 114, via the data bus 210, the address bus 208, a command bus, or a combination of the address bus 208, the data bus 210, or the command bus. The prefetch logic module 112 can then determine an updated prefetching configuration, based at least in part on the prefetch-success indicator 306, and transmit the updated prefetching configuration over the interconnect 114 (e.g., to transmit the updated prefetching configuration to the memory device 302).

The prefetch logic module 112 can also receive the prefetch-quality indicator 308 from the interconnect 114 and determine the updated prefetching configuration, based at least in part on the prefetch-success indicator 306 and the prefetch-quality indicator 308. For example, the prefetch logic module 112 can use the prefetch-success indicator 306 to determine memory addresses to maintain in the intermediate memory 108 (e.g., an address that is reported as a “miss” can be prefetched to the intermediate memory 108 so that the address is a hit the next time it is requested). In implementations that include the prefetch-quality indicator 308, the prefetch logic module 112 can use the prefetch-quality indicator 308 to determine memory addresses to prioritize, based on being frequently requested (e.g., tens, hundreds, or thousands of requests per workload or thread). In this way, the prefetch logic module 112 can use either or both the prefetch-success indicator 306 or the prefetch-quality indicator 308 to train or update the prefetching configuration 304 to make more-accurate predictions of data to prefetch into the intermediate memory 108.

The prefetch logic module 112 can train the prefetching configuration 304 in a variety of ways, such as by adjusting attributes of the prefetching configuration 304 to produce the updated prefetching configuration. When the prefetching configuration 304 includes at least part of a neural network, example attributes that can be adjusted include network topology or structure (e.g., the types and number of layers or nodes, or the number of interconnections between nodes), weights of nodal connections, and biases. For instance, training can reduce or increase weights of nodal connections and/or biases of nodes of the neural network based on feedback from the memory device 302, such as the prefetch-success indicator 306 and the prefetch-quality indicator 308. In other cases, when the prefetching configuration 304 is another type of configuration, such as a memory-access-history table (e.g., with cache-miss data or cache-miss strides or depths) or a Markov model, example attributes that can be adjusted include stride, depth, or parameters of the Markov model, such as states or probabilities.

In some implementations, the memory device can receive multiple prefetching configurations (or commands for the multiple prefetching configurations) that are produced for particular programs, processes, or workloads executed or performed by the host device or a processor of the host device (e.g., a customized prefetching configuration). For example, the prefetch engine 118 can receive multiple workload-specific prefetching configurations 310 (or multiple commands for the multiple workload-specific prefetching configurations 310) from the host device over the interconnect 114 using the interface 122. The workload-specific prefetching configurations 310 respectively correspond to all or part of multiple different workloads of a process or program operated by the host device. Based at least in part on a workload-specific prefetching configuration of the multiple workload-specific prefetching configurations 310 that corresponds to a current workload, the prefetch engine 118 can predict respective memory addresses of the backing memory 120 that may be requested by the host device for the current workload of the multiple different workloads. The prefetch engine 118 can then load data associated with the predicted memory addresses of the backing memory 120 into the intermediate memory 108 based on the workload-specific prediction.

Further, in some cases the memory device may receive memory-address requests that are interleaved for multiple processes, programs, or workloads. For example, in a multi-core processor, multiple workloads may operate at the same time and intermix their memory-address requests. The host device (e.g., the prefetch logic module 112) can associate the multiple memory-address requests (e.g., from different programs, processes, and/or workloads) with the appropriate workload-specific prefetching configuration 310 and provide that information to the memory device so that the prefetch engine 118 can use the correct respective prefetching configuration for different memory-address requests. Because the predictions described herein are made using a prefetching configuration that is based on operations of the host device (and updated based on the accuracy and quality of the predictions), the performance of the memory system and host device operations can suffer when the workload changes. Accordingly, using workload-specific prefetching configurations 310 that are provided to the prefetch engine 118 when a new corresponding workload is started can maintain the efficiency and accuracy of the host-assisted memory-side prefetcher, even across changing workload and program operations.

In still other implementations (not explicitly shown in FIG. 3), the host-assisted memory-side prefetcher can use a technique called transfer learning when the prefetching configuration 304 includes, for instance, a relatively large pre-trained neural network. For example, a neural network may have a larger-than-usual number of network layers, nodes, and/or connections. The prefetching configuration 304 may be initially trained using any of a variety of techniques (e.g., a cloud-based service or offline profiling of the workload). Then, while prefetch engine 118 is operating with this trained configuration, the prefetch engine 118 can monitor a current program, process, or workload being executed by the host device 102.

Based on the monitoring, the prefetch engine 118 (or the host device 102) can determine an adjustment or modification to one or more (but not all) of the network layers to tune the prefetching configuration 304 to adapt to the nuances of the program, process, or workload. For example, the complex pre-trained prefetching configuration 304 can capture general workload behavior across a wide range of input data. For the specific inputs that the system is currently being used for, the prefetch engine 118 adjusts, for example, the last linear layer of the prefetching configuration 304 to better predict its observed behavior (e.g., to improve the predicting of the memory addresses of the backing memory that may be requested by the host device). While a memory-device-side implementation of transfer learning can involve having more compute and process resources on the memory device than if all the retraining is performed on the host side, it may still involve substantially fewer resources than retraining the entire neural network on the memory-device side. Further, employing transfer learning on the memory-device side may provide fine-tuning sooner than waiting for the prefetch logic module 112 to update the entire prefetching configuration 304.

FIG. 4 illustrates another example apparatus 400 that can implement aspects of a host-assisted memory-side prefetcher. The example apparatus 400 comprises the host device 102 and an interface 402 configured to couple to an interconnect 114 for a memory device. For clarity, the host device 102 is depicted to include the processor 106, the memory controller 110, and the prefetch logic module 112, but the host device 102 may include more, fewer, or different components. The host device 102 can include or be realized as any of a variety of processors, such as a graphics processing unit (GPU), a central processing unit (CPU), or cores of a multi-core processor. The interface 402 can be any of a variety of interfaces that can couple the host device 102 to the interconnect 114, including buffers, latches, drivers, receivers, or a protocol to operate them. For example, the interface 402 can be implemented as any of a variety of circuitries, devices, or systems capable of enabling data or other signals to be communicated between the host device 102 and the memory device 104 (e.g., as described with reference to the interface 122).

As shown in FIG. 4, the interconnect 114 includes the address bus 208 and the data bus 210. In other implementations (not shown), the interconnect 114 can include other communication paths, such as a command bus. The interconnect 114 allows the host device 102 to couple to another device, such as the memory devices 104, 202, or 302. The example apparatus 400 depicts the host device 102 coupled to the interconnect 114 through the interface 402. In other cases, the host device 102 may be coupled to the interconnect 114 via another component, such as the memory controller 110. As illustrated, the processor 106 is coupled, directly or indirectly, to the memory controller 110, the prefetch logic module 112, and the interface 402. The memory controller 110 is also coupled, directly or indirectly, to the prefetch logic module 112 and the interface 402. The prefetch logic module 112 is connected, directly or indirectly, to the interface 402.

The prefetch logic module 112 can be implemented in a variety of ways. In some cases, the prefetch logic module 112 can be realized as an artificial intelligence accelerator (e.g., a Micron Deep Learning Accelerator™). In other cases, the prefetch logic module 112 can be realized as an application-specific integrated circuit (ASIC) that includes a processor and memory, or another logic controller with sufficient compute and process resources to produce and train neural networks and other prefetching configurations, such as the prefetching configuration 304. As shown, the prefetch logic module 112 is included in the host device 102 as a separate component, but in other implementations, the prefetch logic module 112 may be included with the processor 106 or the memory controller 110. In still other implementations, the prefetch logic module 112 can be an entity that is separate from, but coupled to, the host device 102, such as through a network-based or cloud-based service.

In example operations, the prefetch logic module 112 can determine a prefetching configuration and transmit the prefetching configuration (or the command for the prefetching configuration) to another component or device. For example, the prefetch logic module 112 can determine the prefetching configuration 304 as described with reference to FIG. 3 and can transmit the prefetching configuration 304 (or the command) to the memory device 104, 202, or 302 over the interconnect 114 (e.g., using the interface 402). Accordingly, the prefetching configuration 304 can be realized with a neural network, a memory-access-history table, (e.g., with cache-miss data, which may include cache-miss strides and/or depths), or another prefetching configuration, such as a Markov model.

In some implementations, the prefetch logic module 112 can also create and maintain customized, workload-specific or program-specific prefetching configurations and transmit them to another device, such as the memory devices 104, 202, or 302. For example, the prefetch logic module 112 can determine a workload-specific prefetching configuration that corresponds to a workload, or portion thereof, associated with a process or program executed by the processor 106 (e.g., the workload-specific prefetching configuration 310, as described with reference to FIG. 3). In response to a start of the workload associated with the process or program (or a notification that the workload is about to start), the prefetch logic module 112 can transmit the workload-specific prefetching configuration 310 (or a command for the workload-specific prefetching configuration 310) to the memory device 104, 202, or 302 over the interconnect 114. Further, as described with reference to FIG. 3, the prefetch logic module 112 can associate multiple workloads or programs with different respective workload-specific prefetching configurations 310 and provide the association information to the memory device at the corresponding time or with the corresponding memory-address request. The memory device can then use the appropriate prefetching configuration for different memory-address requests that are associated with different workloads, such as for multi-core processors, which may operate multiple workloads at the same time and intermix their memory-address requests.

Continuing the example operations, the prefetch logic module 112 can receive the prefetch-success indicator 306 (and, optionally, other data related to the accuracy and quality of the predictions, such as the prefetch-quality indicator 308) from the memory device 104, 202, or 302 via the interconnect 114. The prefetch logic module 112 can determine an updated prefetching configuration 404 based at least in part on either or both of the prefetch-success indicator 306 or the other data (e.g., the prefetch-quality indicator 308). The prefetch logic module 112 can then transmit the updated prefetching configuration 404 (or a command for the updated prefetching configuration 404) to the memory device 104, 202, or 302 over the interconnect 114 (e.g., using the interface 402).

The prefetch logic module 112 can determine the updated prefetching configuration 404 based on one or more trigger events. For example, when the host device 102 starts a new program, process, or workload, it can determine an updated prefetching configuration 404 for that new operation. In other implementations, the host device 102 can monitor the effectiveness of the prefetcher (e.g., using the data related to the accuracy and quality of the predictions, such as the prefetch-success indicator 306 and/or the prefetch-quality indicator 308). When the effectiveness drops by a threshold amount or below a threshold level, the prefetch logic module 112 can update the current prefetching configuration. Example threshold amounts include the cache-hit rate decreasing by three, five, or seven percent or the cache-miss rate increasing by three, five, or seven percent. In yet other implementations, the prefetch logic module 112 can determine the updated prefetching configuration 404 on a schedule. A schedule can expire or conclude, for example, when a threshold amount of operating time has elapsed since the most recent update (e.g., 30, 90, or 180 minutes), or when a threshold number of memory-address requests have been made since the most recent update. Thus, the prefetch logic module 112 may operate to determine the updated prefetching configuration 404 based on a periodic schedule, based on a trigger event (including performance degradation or starting/changing operations), or based on a combination of trigger events and schedules (e.g., a periodic update that may be pre-empted by a trigger event).

In some implementations, the prefetch logic module 112 can transmit, along with the memory-address request, information that indicates whether the memory-address request is a result of a cache miss or a prefetch generated by the host processor. Generally, these cache-misses and prefetches may be given less weight in the prefetching configuration than a demand miss. These indications can be considered, in addition to or instead of the prefetch-success indicator 306 or the prefetch-quality indicator 308, by the prefetch logic module 112 to determine the updated prefetching configuration 404.

In some implementations, the prefetching configuration includes or is realized as at least part of an artificial neural network. The prefetch logic module 112 can determine the prefetching configuration by determining a network structure of the artificial neural network and determining one or more parameters of the artificial neural network. For example, the prefetching configuration 304 or the updated prefetching configuration 404 can be implemented using a recurrent neural network (RNN) (with or without long short-term memory (LSTM) architecture). The RNN may comprise multiple layers of nodes that are connected via nodal connections (e.g., nodes or neurons of one layer that are connected to some or all of the nodes or neurons of another layer). The one or more parameters of the artificial neural network can include a weight value for at least one of the nodal connections and a bias value for at least one of the nodes. In other cases, the prefetching configuration 304 or the updated prefetching configuration 404 can be implemented with another type of prefetching configuration. Other types of prefetching configurations include for example, a memory-address-history table that includes cache-miss data, such as cache-miss addresses (with or without cache-miss strides and/or depths) and a Markov model that can also include a global history buffer.

In some implementations, in addition to or instead of using trigger events, the prefetch logic module 112 can transmit the updated prefetching configuration 404 (or the command for the updated prefetching configuration 404) to the memory device (104, 202, or 302) intermittently and/or in pieces. The prefetch logic module 112 can transmit the updated prefetching configuration 404 (or the command) using idle bandwidth of the host device 102 (e.g., times when the host device 102 and/or the processor 106 are not operating at full capacity and/or not fully utilizing the interconnect 114) to thereby provide intermittent updates. In these implementations, rather than transmitting the entire updated prefetching configuration 404 all at once, the prefetch logic module 112 can monitor computing and processing resources of the host device 102 and any changes to the prefetching configuration 304 (e.g., the changes precipitated by the prefetch-success indicator 306 and/or the prefetch-quality indicator 308). For example, the prefetch logic module 112 may determine that a nodal connection weight has changed more than other nodal connection weights over a recent time period (e.g., has changed in excess of a threshold change, such as more than two percent, more than five percent, or more than ten percent) or a nodal connection weight that has a greater overall influence on the outputs than the weight of other nodes

Based on the monitoring, the prefetch logic module 112 can also determine when excess computing or processing resources of the host device 102 and/or bandwidth on the interconnect 114 are available. The prefetch logic module 112 can transmit all or part of the updated prefetching configuration 404 (e.g., a partial prefetching configuration) when excess capacity is available. An example transmission mechanism for communicating a nodal connection weight or bias value is a matrix location and the corresponding updated value. Thus, for a two-dimensional (2D) weight matrix, an example of a weight update at a position (x, y) of the matrix could be (x, y new value). In this way, the prefetch logic module 112 can keep the prefetching configuration updated more frequently, while impacting or using fewer resources, to increase the efficiency and accuracy of the host-assisted memory-side prefetcher.

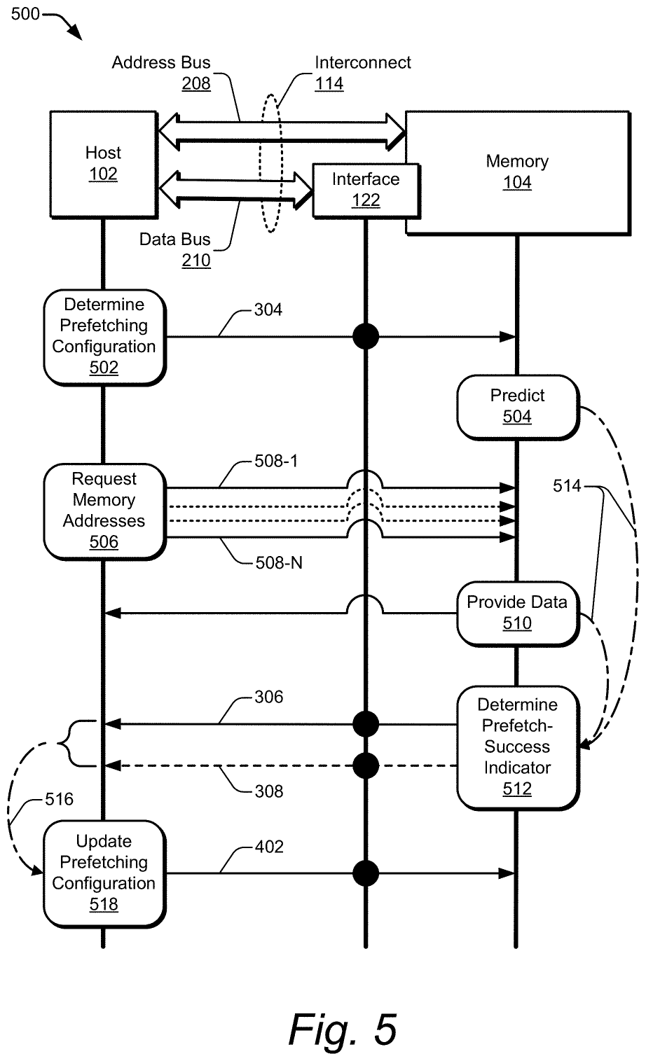

FIG. 5 illustrates an example sequence diagram 500 with operations and communications of the host device 102 and the memory device 104 to use a host-assisted memory-side prefetcher. In this example, the memory device 104 includes the interface 122, which can couple to the interconnect 114. The host device 102 is also coupled to the interconnect 114. At the host device 102, the prefetch logic module 112 (e.g., of FIGS. 1, 2, and 4) performs various operations. At the memory device 104, the prefetch engine 118 (e.g., of FIGS. 1, 2, and 3) performs the depicted operations.

At 502, the prefetch logic module 112 determines the prefetching configuration 304 and transmits it over the interconnect 114 for receipt at the interface 122. The prefetch engine 118 receives the prefetching configuration 304 (or the command for the prefetching configuration 304) via the interface 122 and, at 504, determines (e.g., predicts) one or more memory addresses of the backing memory that may be requested by the host device 102, based at least in part on the prefetching configuration 304. In other words, as described with reference to FIG. 3, the memory addresses that may be requested are memory addresses that, from a probabilistic perspective based on the prefetching configuration, will be (or are likely to be) requested by the host device within some future timeframe. The memory device 104 then writes or loads or writes the data associated with the predicted memory addresses into the intermediate memory 108 (not shown). At 506, the host device 102 transmits memory-address requests 508-1 through 508-N (with “N” representing a positive integer) to the memory device 104 during normal operation of a program, process, or application being executed by the host device 102. In some cases, the host device 102 can also send program counter information, such as an instruction pointer or the address of the read/write instructions to facilitate making predictions for prefetching or the tracking of predictions that have been made. At 510, the data associated with the memory-address requests 508-1 through 508-N is provided to the host device 102, either from the intermediate memory 108 (e.g., a hit) or from the backing memory 120 (e.g., a miss).

At 512, the prefetch engine 118 uses information (e.g., the prediction information from operation 504 and the hit and miss information from operation 510), as represented by dash-lined arrows 514, to determine the prefetch-success indicator 306 and, optionally, the prefetch-quality indicator 308. The memory device 104 then transmits the prefetch-success indicator 306 and/or the prefetch-quality indicator 308 to the host device 102 via the interface 122 and over the interconnect 114. The prefetch logic module 112 receives the prefetch-success indicator 306 and/or the prefetch-quality indicator 308, as shown by a dashed-line arrow 516. At 518, the prefetch logic module 112 determines the updated prefetching configuration 404 and transmits the configuration (or a command therefor) over the interconnect 114 for receipt by the interface 122. As the operations of the host device 102 continue, the prefetch logic module 112 can continue to maintain and update the prefetching configuration and transmit an updated version thereof to the prefetch engine 118. Further, the prefetch engine 118 can use the prefetching configuration to continue predicting memory-address requests and prefetching data corresponding to the predicted memory addresses from the backing memory 120 for writing or loading into the intermediate memory 108.

The described apparatus and techniques for a host-assisted memory-side prefetcher allow a host device to provide complex, sophisticated, and accurate prefetching configurations that may not otherwise be available to a memory-side prefetcher because of the resources involved to produce and maintain these types of configurations. In turn, memory and storage system performance can be improved (e.g., memory latency may be reduced), thereby enabling the host device to operate faster and more efficiently.

### Example Methods

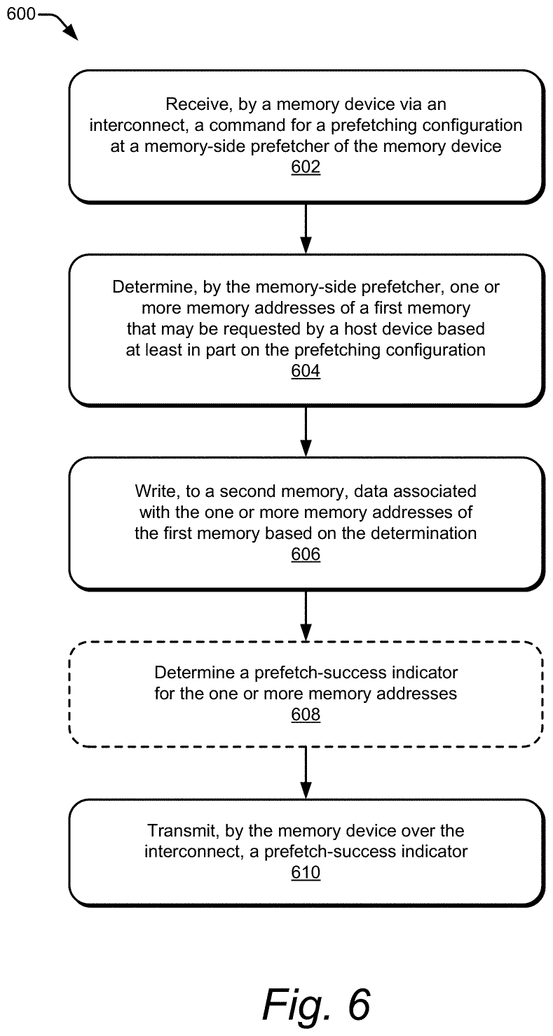

FIG. 6 depicts an example method 600 for a memory device to use a host-assisted memory-side prefetcher. Operations are performed by a memory device that can be coupled to a host device through an interconnect. The host device can include a prefetch logic module, and the memory device can include a prefetch engine (e.g., a memory-side prefetcher), in accordance with the described host-assisted memory-side prefetcher. In some implementations, operations of the example method 600 may be managed, directed, or performed by the memory device (104, 202, or 302) or a component of the memory device, such as the prefetch engine 118 or the controller 116. The following discussion may reference the example apparatus 100, 200, 300, or 400 of FIGS. 1 through 4, or entities or processes as detailed in other figures, reference to which is made only by way of example.

At 602, the memory device receives a prefetching configuration at a memory-side prefetcher of the memory device via the interconnect. For example, a memory device having a memory-side prefetcher (e.g., the memory device 104 or the example memory device 202 or 302) can receive the prefetching configuration 304 or a command for the prefetching configuration 304 over the interconnect 114 using the interface 122. The command may include a signal or another mechanism that indicates that the memory-side prefetcher is to use a particular prefetching configuration, such as the prefetching configuration 304. In some implementations, the prefetching configuration 304 can include at least part of an artificial neural network, a memory-access-history table (e.g., with cache-miss data, including cache-miss strides and/or depths), or a Markov model. In some cases, the memory device can receive the prefetching configuration (or the command) over the interconnect from or through a host device, such as the host device 102. In other cases, the memory device can receive the prefetching configuration (or the command) from another source, such as a cloud-based service or a network-based service.

At 604, the memory-side prefetcher determines (e.g., predicts) one or more memory addresses of a first memory (e.g., a backing memory) that may be requested by the host device, based at least in part on the prefetching configuration. For example, the memory device 104 can predict one or more memory addresses of the backing memory 120 that may be requested by the host device 102. The memory device 104 can use the prefetch engine 118 to make the prediction, based at least in part on the prefetching configuration 304. In other words, as described with reference to FIG. 3, the memory addresses that may be requested are memory addresses that, from a probabilistic perspective based on the prefetching configuration, will be (or are likely to be) requested by the host device within some future timeframe.

At 606, the memory device writes or loads data associated with the one or more predicted memory addresses into a second memory (e.g., an intermediate memory) based on the prediction. For example, the memory device 104 can write or load data associated with the memory addresses predicted by the prefetch engine 118 into the intermediate memory 108 before these memory addresses are requested by the host device. The intermediate memory 108 may be located at the memory device 104, at the host device 102, and so forth.

In some implementations, at 608, the memory device determines a prefetch-success indicator for the one or more predicted memory addresses. For example, the memory device 104 can determine the prefetch-success indicator 306. The prefetch-success indicator 306 can indicate, for example, that the host accessed at least one predicted memory address from the intermediate memory 108 before the predicted memory address is evicted from the intermediate memory 108. In some cases, the memory device 104 can also determine the prefetch-quality indicator 308, as described with reference to FIG. 3.

At 610, the memory device transmits the prefetch-success indicator over the interconnect. For example, the memory device 104 can transmit the prefetch-success indicator 306 over the interconnect 114 using the interface 122. In some implementations, the memory device can transmit the prefetch-success indicator 306 over the interconnect to a host device (e.g., the host device 102) or to another entity, such as a cloud-based service or a network-based service.

The example method 600 may include additional acts or operations in some implementations (not shown in FIG. 6). For example, the memory device can also receive, via the interconnect, an updated prefetching configuration or a command for the updated prefetching configuration. The updated prefetching configuration (or the command) may be received over the interconnect from or through a host device or another source, such as a cloud-based service or a network-based service. The memory-side prefetcher can use the updated prefetching configuration to determine or predict additional backing-memory addresses that may be requested. Based on the prediction, the memory device can then write or load additional data associated with the additional predicted memory addresses into the intermediate memory. For example, the memory device 104 can receive the updated prefetching configuration 404 through the interface 122 over the interconnect 114 (e.g., from the host device 102 or another entity as described herein). The updated prefetching configuration 404 may be based, at least in part, on either or both the prefetch-success indicator 306 or the prefetch-quality indicator 308. Further, based at least in part on the updated prefetching configuration 404, the memory device 104 (e.g., using the prefetch engine 118) can predict one or more other memory addresses of the backing memory 120 that may be requested by the host device 102. Based on the predictions, the memory device 104 can write or load other data associated with the other predicted memory addresses of the backing memory 120 into the intermediate memory 108.

In another example (not explicitly shown in FIG. 6), the host-assisted memory-side prefetcher can use a technique called transfer learning, as described with reference to FIG. 3 (e.g., when the prefetching configuration 304 includes a neural network having a larger-than-usual number of network layers, nodes, and/or connections). Using this technique, the prefetch engine 118 can monitor a current program, process, or workload being executed by the host device 102. Based on the monitoring, the prefetch engine 118 (or the host device 102) determines an adjustment or modification to one or more (but not all) of the network layers, which can tune the prefetching configuration 304 to adapt to the nuances of the program, process, or workload. For the specific inputs that the system is currently operating under, the prefetch engine 118 adjusts, for example, the last linear layer of the prefetching configuration 304 to better predict its observed behavior (e.g., to improve the predicting of the memory addresses of the backing memory that may be requested by the host device). While a memory-device-side implementation of transfer learning can involve having more compute and process resources on the memory device than if all the retraining is performed on the host side, it may still involve substantially fewer resources than retraining the entire neural network on the memory-device side. Further, employing transfer learning on the memory-device side may provide fine-tuning sooner than waiting for the prefetch logic module 112 to update the entire prefetching configuration 304.

The described methods for a host-assisted memory-side prefetcher allow complex, sophisticated, and accurate prefetching configurations that may otherwise be unavailable for a memory-side prefetcher because of the resources involved to produce and maintain these types of configurations. In turn, memory and storage system performance can be improved (e.g., memory latency may be reduced), thereby enabling the host device to operate faster and more efficiently.

For the flow diagram described above, the orders in which operations are shown and/or described are not intended to be construed as a limitation. Any number or combination of the described process operations can be combined or rearranged in any order to implement a given method or an alternative method. Operations may also be omitted from or added to the described methods. Further, described operations can be implemented in fully or partially overlapping manners.

Aspects of these methods may be implemented in, for example, hardware (e.g., fixed-logic circuitry or a processor in conjunction with a memory), firmware, or some combination thereof. The methods may be realized using one or more of the apparatuses or components shown in FIGS. 1-5, the components of which may be further divided, combined, rearranged, and so on. The devices and components of these figures generally represent firmware or the actions thereof; hardware, such as electronic devices, packaged modules, IC chips, or circuits; software; or a combination thereof. The illustrated apparatuses 100, 200, 300, and 400 include, for instance, one or more of a host device 102, a memory device 104/202/302, or an interconnect 114.

The host device 102 can include a processor 106, an intermediate memory 108, a memory controller 110, a prefetch logic module 112, and an interface 402. The memory devices 104, 202, and 302 can include an intermediate memory 108, a controller 116, a prefetch engine 118, a backing memory 120, and an interface 122. Thus, these figures illustrate some of the many possible systems or apparatuses capable of implementing the described methods. Computer-readable media includes both non-transitory computer storage media and communication media including any medium that facilitates transfer of a computer program or other executable code, such as an application, a prefetching configuration, a prefetch-success indicator, or a prefetch-quality indicator, from one entity to another. Non-transitory storage media can be any available medium accessible by a computer, such as RAM, ROM, EEPROM, compact disc ROM, and magnetic disk.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

### CONCLUSION

Although implementations for a host-assisted memory-side prefetcher have been described in language specific to certain features and/or methods, the subject of the appended claims is not necessarily limited to the specific features or methods described. Rather, the specific features and methods are disclosed as example implementations for the host-assisted memory-side prefetcher.

1. A method comprising:
receiving, from a host device via an interconnect, a command for a prefetching configuration at a prefetch engine of a memory device;
determining, by the prefetch engine, one or more memory addresses of a first memory that may be requested by the host device based at least in part on the prefetching configuration;
writing, to a second memory, data associated with the one or more memory addresses of the first memory based on the determination; and
transmitting to the host device, by the memory device over the interconnect, a prefetch-success indicator.

2. The method of claim 1, further comprising determining the prefetch-success indicator for the one or more memory addresses, the prefetch-success indicator comprising an indication that the host device accessed at least one memory address of the one or more memory addresses from the second memory before the at least one memory address is evicted from the second memory.

3. The method of claim 1, further comprising:
receiving, by the memory device via the interconnect, a command for an updated prefetching configuration, the updated prefetching configuration based at least in part on the prefetch-success indicator;
determining, by the prefetch engine, one or more other memory addresses of the first memory that may be requested by the host device based at least in part on the updated prefetching configuration; and
writing, to the second memory, other data associated with the one or more other memory addresses of the first memory based on the determination of the one or more other memory addresses.

4. The method of claim 1, wherein the prefetching configuration comprises a trained neural network having multiple network layers, and the method further comprises:
monitoring, by the prefetch engine, a current operation of the host device;
determining, by the prefetch engine or the host device and based on the monitoring, an adjustment to one or more layers of the trained neural network, the one or more layers comprising less than all layers of the multiple network layers of the trained neural network; and
causing, by the prefetch engine or the host device, the adjustment to the one or more layers, the adjustment effective to improve the determining of the one or more memory addresses of the first memory that may be requested by the host device.

5. The method of claim 1, further comprising:
receiving, from the host device by the memory device via the interconnect, the command for the prefetching configuration at the prefetch engine of the memory device;
transmitting, to the host device by the memory device over the interconnect, the prefetch-success indicator; and
determining, by the host device, an updated prefetching configuration based at least in part on the prefetch-success indicator.

6. An apparatus, comprising:
an interface configured to couple to an interconnect for a host device;
a first memory;
a second memory coupled to the first memory; and
a controller coupled to the first memory and the second memory, the controller including or associated with a prefetch engine of a memory device, the prefetch engine configured to:
receive a command for a prefetching configuration from a prefetch logic module of the host device via the interconnect using the interface;
determine, based at least in part on the prefetching configuration, one or more memory addresses of the first memory that may be requested by the host device;
write data associated with the one or more memory addresses of the first memory to the second memory based on the determination; and
transmit a prefetch-success indicator to the host device over the interconnect using the interface.

7. The apparatus of claim 6, wherein the prefetch engine is further configured to determine the prefetch-success indicator for the one or more memory addresses, the prefetch-success indicator comprising an indication that at least one memory address of the one or more memory addresses is accessed via the second memory before the at least one memory address is evicted from the second memory.

8. The apparatus of claim 6, wherein the interface comprises a memory-mapped register that is configured to couple to the interconnect.

9. The apparatus of claim 6, wherein:
the prefetching configuration comprises a recurrent neural network (RNN); and
the prefetch engine comprises a neural-network-based prefetcher configured to determine, based at least in part on the RNN, the one or more memory addresses of the first memory that may be requested by the host device.

10. The apparatus of claim 6, wherein:
the prefetching configuration comprises cache-miss data, including at least cache-miss strides; and
the prefetch engine comprises a table-based prefetcher configured to determine, based at least in part on the cache-miss data, the one or more memory addresses of the first memory that may be requested by the host device.

11. The apparatus of claim 6, wherein the prefetch engine is further configured to:
determine a prefetch-quality indicator for the one or more memory addresses, the prefetch-quality indicator comprising at least a number of times the one or more memory addresses are accessed via the second memory during operation of a program, a workload, or a portion thereof; and
transmit the prefetch-quality indicator to the host device over the interconnect using the interface.

12. The apparatus of claim 6, further comprising the host device, the host device coupled to the interface via the interconnect and including, or associated with, the prefetch logic module, the prefetch logic module configured to:
determine the prefetching configuration;
transmit the command for the prefetching configuration over the interconnect;
receive the prefetch-success indicator via the interconnect;
determine, based at least in part on the prefetch-success indicator, an updated prefetching configuration; and
transmit another command for the updated prefetching configuration over the interconnect.

13. The apparatus of claim 12, wherein the prefetch logic module is further configured to:
receive a prefetch-quality indicator via the interconnect; and
determine, based at least in part on the prefetch-success indicator and the prefetch-quality indicator, the updated prefetching configuration.

14. The apparatus of claim 6, wherein the prefetch engine is further configured to:
receive multiple commands for multiple workload-specific prefetching configurations from the host device via the interconnect using the interface, the multiple commands for the multiple workload-specific prefetching configurations respectively corresponding to multiple different workloads of a process or program executed by the host device;
determine respective memory addresses of the first memory that may be requested by the host device for a respective workload of the multiple different workloads, based at least in part on a respective workload-specific prefetching configuration of the multiple workload-specific prefetching configurations that corresponds to the respective workload; and
write data associated with the respective memory addresses of the first memory to the second memory based on the determination.

15. The apparatus of claim 6, wherein the second memory comprises:
a memory-side cache memory;
a memory-side buffer memory;
a host-side cache memory;
a host-side buffer memory; or
any combination thereof.

16. The apparatus of claim 6, wherein the first memory comprises:
a nonvolatile memory device;
a dynamic random-access memory (DRAM) device;
a phase-change memory device;
a magnetic hard drive;
a solid-state drive (SSD);
a backing memory associated with the memory device; or
any combination thereof.

17. An apparatus comprising:
an interface configured to couple to an interconnect for a memory device;
at least one processor; and
a prefetch logic module associated or included with a host device and coupled to the at least one processor, the prefetch logic module configured to:
determine a prefetching configuration;
transmit a first command for the prefetching configuration to a prefetch engine of the memory device over the interconnect;
receive a prefetch-success indicator from the prefetch engine of the memory device via the interconnect;
determine an updated prefetching configuration based at least in part on the prefetch-success indicator; and
transmit a second command for the updated prefetching configuration to the prefetch engine of the memory device over the interconnect.

18. The apparatus of claim 17, wherein the prefetch logic module is further configured to:
monitor computing or processing resources associated with the apparatus;
determine at least one time period with unused computing or processing resources;
monitor changes to the prefetching configuration based at least in part on the prefetch-success indicator or a prefetch-quality indicator;
determine, based at least in part on the changes to the prefetching configuration, a partial updated prefetching configuration; and
transmit, during the at least one time period with the unused computing or processing resources, a third command for the partial updated prefetching configuration to the memory device over the interconnect.

19. The apparatus of claim 17, wherein the prefetch logic module is further configured to:
determine a workload-specific prefetching configuration that corresponds to a workload associated with a process or program executed by the at least one processor; and
transmit, responsive to a start of the workload associated with the process or program, a third command for the workload-specific prefetching configuration to the memory device over the interconnect.

20. The apparatus of claim 17, wherein the prefetching configuration comprises at least a portion of an artificial neural network, and the prefetch logic module is further configured to determine the prefetching configuration by determining a network structure of the artificial neural network and one or more parameters of the artificial neural network.

21. The apparatus of claim 20, wherein:
the network structure of the artificial neural network comprises multiple layers of nodes that are connected to each other via nodal connections; and
the one or more parameters of the artificial neural network include one or more of:
a weight value for at least one of the nodal connections; or
a bias value for at least one of the nodes.

22. The apparatus of claim 17, wherein the prefetching configuration comprises at least one of:
a memory-access-history table that includes one or more of cache-miss addresses or a stride; or
a Markov model that includes a global history buffer.
